(19) United States
(12) Patent Application Publication
(10) Pub. No.: US 2013/0191341 A1
(43) Pub. Date: Jul. 25, 2013

(54) METHODS AND APPARATUS FOR RESTORING A USER-SELECTED SUBSET OF APPLICATION DATA

(71) Applicant: BACKUPIFY, INC., Cambridge, MA (US)

(72) Inventors: Eric Robert Alexander, Louisville, KY (US); Matthew Ronald Blevins Conway, Weymouth, MA (US); Ben Thomas, Cambridge, MA (US)

(73) Assignee: BACKUPIFY, INC., Cambridge, MA (US)

(21) Appl. No.: 13/746,763

(22) Filed: Jan. 22, 2013

Related U.S. Application Data
(60) Provisional application No. 61/589,053, filed on Jan. 20, 2012.

(51) Int. Cl. G06F 11/14

(52) U.S. Cl. CPC G06F 11/1464
USPC 707/640; 707/674

(57) ABSTRACT

In some embodiments, an apparatus includes a backup module configured to receive, from a compute device, a copy of user data associated with a user and generated at the compute device. The backup module is configured to store the copy of user data in a storage device. The backup module is configured to provide a user interface for the user to access the copy of user data. The backup module is configured to receive, from a user device associated with the user, an indication of a subset of the copy of user data. The backup module is configured to, in response to the indication, retrieve the subset of the copy of user data from the storage device and send the subset of the copy of user data to the compute device such that the subset of the copy of user data is restored at the compute device.

### CROSS-REFERENCE TO RELATED APPLICATIONS

This application claims priority to and the benefit of U.S. Provisional Patent Application No. 61/589,053, entitled “METHODS AND APPARATUS FOR RESTORING A USER-SELECTED SUBSET OF APPLICATION DATA FROM A REMOTE LOCATION”, filed on Jan. 20, 2012, which is incorporated herein by reference in its entirety.

### BACKGROUND

Some embodiments described herein relate generally to data restoration, and, in particular, to methods and apparatus for restoring user-selected application data from a remote location.

Some known data restore tools are used to backup user data by generating backup copies of the user data, and restore the original user data from the backup copies. Such known data restore tools, however, typically do not provide a view of the backup user data that mimics the view of the original user data displayed at the originating device. Furthermore, copies of the user data are typically stored at locations at or near the originating device instead of being distributed to remote locations. Additionally, the restoring process might be complicated for a user to operate.

Accordingly, a need exists for methods and apparatus that can store backup user data at and restore user data from a remote location, mimic a view of the original user data, and/or simplify the restoring process.

### SUMMARY

In some embodiments, an apparatus includes a backup module configured to receive, from a compute device, a copy of user data associated with a user and generated at the compute device. The backup module is configured to store the copy of user data in a storage device. The backup module is configured to provide a user interface for the user to access the copy of user data. The backup module is configured to receive, from a user device associated with the user, an indication of a subset of the copy of user data. The backup module is configured to, in response to the indication, retrieve the subset of the copy of user data from the storage device and send the subset of the copy of user data to the compute device such that the subset of the copy of user data is restored at the compute device.

### BRIEF DESCRIPTION OF THE DRAWINGS

FIG. 1 is a schematic illustration that includes a backup-restore device configured to backup and restore user data, according to an embodiment.

FIG. 2A is a schematic illustration of a user interface configured to display information for backup user data, according to an embodiment.

FIG. 2B is a schematic illustration of a user interface configured to display information for backup user data, according to another embodiment.

FIG. 3 is a flowchart illustrating a method for backing up and restoring user data, according to an embodiment.

### DETAILED DESCRIPTION

In some embodiments, an apparatus includes a backup module that is operatively coupled to a compute device via a network such as, for example, the Internet. The backup module is configured to receive, from the compute device, a copy of user data associated with a user and generated at the compute device. In some instances, user data substantially corresponding to the copy of user data can be stored in a first storage device operatively coupled to the compute device. In some instances, the backup module is configured to receive the copy of user data from the compute device using at least one of Hypertext Transfer Protocol (HTTP) Application Programming Interface (API) calls, scheduled data exports, or automated data exports.

The backup module is configured to store the copy of user data in a second storage device that is operatively coupled to the backup module and separate from the compute device. The backup module is configured to provide a user interface for the user to access the copy of user data stored in the storage device. In some instance, such a user interface substantially mimics a user interface provided by the compute device that displays information of the user data substantially corresponding to the copy of user data.

The backup module is configured to receive, from a user device associated with the user, an indication of a subset of the copy of user data. The backup module is configured to, in response to the indication, retrieve the subset of the copy of user data from the second storage device and send the subset of the copy of user data to the compute device such that the subset of the copy of user data is restored at the compute device.

In some instances, the user data substantially corresponding to the copy of user data can be generated within a Software as a Service (SaaS) application at the compute device. In such instances, the backup module can be configured to send the subset of the copy of the user data to the compute device such that the SaaS application accesses the subset of the copy of the user data.

In some instances, the backup module is separate from the user device. Furthermore, the backup module is configured to receive the copy of user data from the compute device without the copy of user data being received at the user device. Similarly, the backup module is configured to send the subset of the copy of user data to the compute device without sending the subset of the copy of user data to the user device.

In some embodiments, an apparatus includes a restore module configured to be operatively coupled to a storage device and a compute device. The restore module is configured to store a copy of user data associated with a user in the storage device. The restore module is configured to provide to a user device associated with the user a user interface to access the copy of user data. In some instance, the user interface substantially mimics a user interface provided by the compute device to access user data substantially corresponding to the copy of user data. In some instances, the user interface includes a search function such that the user can search contents from the copy of user data stored in the storage device.

The restore module is configured to receive, from the user device, an indication of a one-step operation on the user interface and associated with a subset of the copy of user data. In some instances, such a one-step operation can be, for example, a click on the user interface. The restore module is further configured to, in response to the indication, retrieve the subset of the copy of user data from the storage device and then send the subset of the copy of user data to the compute device such that the subset of the copy of user data is restored at the compute device. In some instances, the restore module is configured to retrieve and send the subset of the copy of user data in response to the indication without receiving any other input from the user device.

As used herein, a module can be, for example, an assembly of hardware or software modules (stored in memory and/or executing in hardware), or a set of operatively-coupled electrical components, and can include, for example, a memory, a processor, electrical traces, optical connectors, software (stored in memory and/or executing in hardware) and/or the like. As used herein, the singular forms “a,” “an” and “the” include plural referents unless the context clearly dictates otherwise. Thus, for example, the term “a storage device” is intended to mean a single device or a set of devices with similar functionalities associated with storing user data.

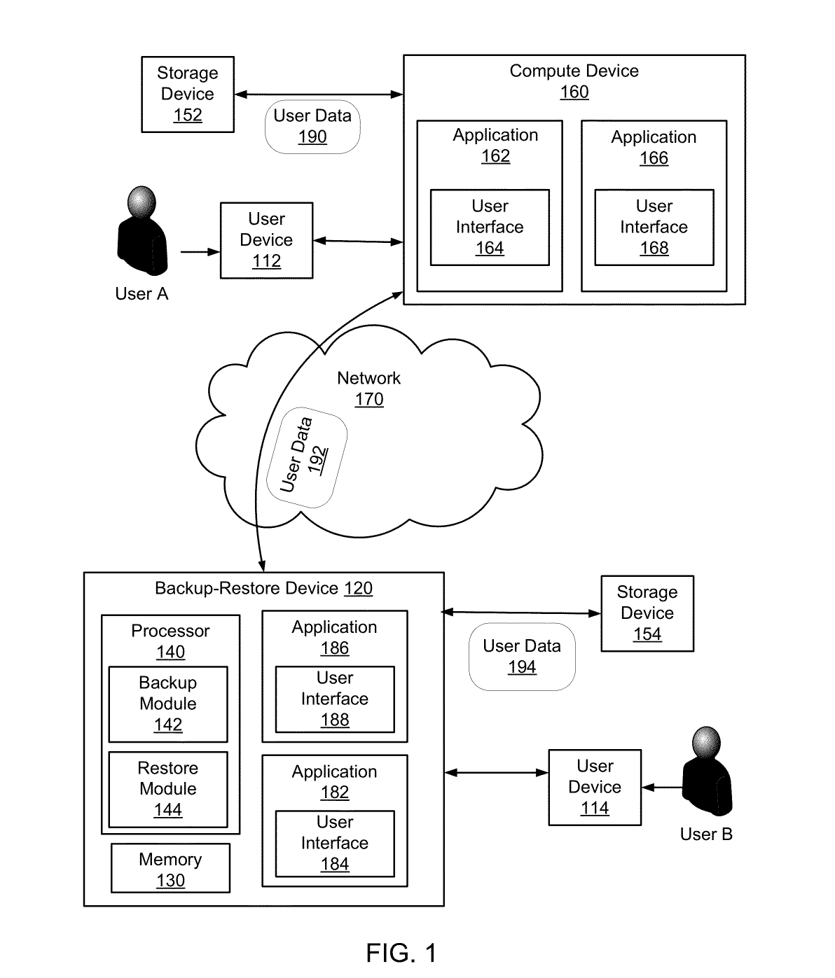

FIG. 1 is a schematic illustration that includes a backup-restore device 120 configured to backup and restore user data, according to an embodiment. The backup-restore device 120 is operatively coupled to a compute device 160 via a network 170. As further described below, user data generated, processed and/or presented at the compute device 160 can be backed up at and restored from the backup-restore device 120. Although not shown in FIG. 1, in some embodiments, a backup-restore device (e.g., the backup-restore device 120) can be operatively coupled to and communicate with more than one compute device; a compute device (e.g., the compute device 160) can be operatively coupled to and communicate with more than one backup-restore device. In such embodiments, user data generated, processed and/or presented at a compute device can be backed up at and restored from more than one backup-restore device. Similarly, a backup-restore device can be used to back up data from and restore data to more than one compute device. In a scenario of multiple backup-restore devices and/or multiple compute devices, each pair of backup-restore device and compute device can operate to back up and restore user data in a similar way as described herein for the backup-restore device 120 and the compute device 160.

The compute device 160 can be any type of device, equipment or component that is used to generate, process, store, present, and/or transmit data. Such a compute device can be, for example, a server device, a networking device, a data processing device, a data storage device, and/or the like. As shown in FIG. 1, the compute device 160 is operatively coupled to a user device 112, a storage device 152 and a network 170. Although not shown in FIG. 1, the compute device 160 can include, for example, a processor, a memory and input/output ports. The input/output ports can be used to communicate externally with, for example, the network 170, the storage device 152, the user device 112, and/or any other devices.

The compute device 160 can be configured to host and execute one or more applications (e.g., applications 162, 166) that are configured to generate, process and/or present user data. Such an application can be software stored within the memory of the compute device 160 and executed by the processor of the compute device 160. In some embodiments, such an application can be referred to as an original hosting application (OHA). Particularly, in some embodiments, an OHA can be, for example, a Software as a Service (SaaS) application or any other suitable type of application that can be used to generate and/or present user data.

User data can be generated, viewed, and/or manipulated within the application 162 or 166 by one or a group of authorized users (e.g., user A in FIG. 1) of the compute device 160 that are associated with the application 162 or 166. Such an authorized user can be, for example, a user subscribing to an Internet service, a user that registered at an online forum, a user belonging to a specific organization, company or group, and/or the like. Typically, a user is requested to provide credentials (e.g., a user name and a password) to an associated application (e.g., the application 162 or 166), where the credentials are authenticated before the user is allowed to access and operate the associated application.

In some embodiments, an authorized user can directly access and operate on the compute device 160, without using any intermediate device, to generate user data. For example, the authorized user can be a network administrator that can access and operate on a server within a data center. In other embodiments, an authorized user can operatively access the compute device 160 (e.g., via a network such as the Internet) using a user device. For example, as shown in FIG. 1, user A accesses the compute device 160 using the user device 112 that is operatively coupled to the compute device 160.

The user device 112 can be any device that is used by a user (e.g., user A) to access user data and perform operations on the user data (e.g., generating user data, manipulating user data, storing user data) using an application (e.g., the application 162 or 166) of the compute device 160. Such a user device can be, for example, a personal computer, a laptop computer, a Personal Digital Assistant (PDA), a tablet, a smart phone, and/or the like. Although not shown in FIG. 1, the user device 112 can include, for example, a processor, a memory, and an input/output port to communicate externally with a communication network (e.g., the Internet) or a compute device (e.g., the compute device 160). In such an embodiment, the user device 112 can operate an application or program to perform functions associated with accessing and operating the application(s) at the compute device 160. The application or program can be software stored within the memory of the user device 112 and executed by the processor of the user device 112. In some embodiments, although not shown in FIG. 1, the user device 112 can be operatively coupled to the compute device 160 via a network such as the Internet. For example, user A can use a personal computer (that is, the user device 112) at home to access a server (that is, the compute device 160) within a remote data center.

In some embodiments, user data can be generated at an application (e.g., the application 162 or 166) within the compute device 160. In such embodiments, for example, user A can operate the application 162 (e.g., using the user device 112 or directly operating the compute device 160) to generate user data. In other embodiments, user data can be generated at a device separate from the compute device 160, and then transmitted from that device to the compute device 160. For example, user data can be generated at the user device 112 under the control of user A, and then uploaded from the user device 112 to the compute device 160. In some embodiments, the user data generated at the separate device can be transmitted from that device to the compute device 160 using any suitable data transmission means such as, for example, a removable storage device (e.g., a removable hard drive, compact disk (CD), floppy disk, portable memory card), a network (e.g., the Internet, a local area network (LAN)), and/or the like.

In some embodiments, different applications hosted and executed at the compute device 160 can be configured to generate, process and/or present different types of user data. An application configured to present user data or information of the user data to a user (e.g., user A in FIG. 1) can present the user data or information of the user data using a user interface associated with that application. Such a user interface can be displayed in a display device or component (e.g., a screen, a monitor, etc.) of the compute device 160 or the user device 112 by executing the associated application or a corresponding portion of the associated application. For example, in response to executing the application 166 that is configured to display information of contact data to user A, a user interface associated with displaying the information of the contact data can be displayed on a monitor of the user device 112. Furthermore, the information of the contact data can be sent from the compute device 160 to the user device 112 such that the information of the contact data is displayed on the user interface at the user device 112. As a result, user A can view the information of the contact data on the monitor of the user device 112.

In some embodiments, a certain type of user data can be generated at an application and presented by a user interface associated with that application. In other embodiments, alternatively, a certain type of user data can be generated at an application and presented by a user interface associated with another application. For example, the application 162 can be an email application (e.g., Microsoft Outlook) configured to generate email data for user A. The application 162 can also be configured to provide a user interface 164 for user A to view the generated email data. For another example, a contact application (not shown in FIG. 1, e.g., Google Contact) can be configured to generate contact data for user A. The application 166 (e.g., Address Book), which is a different application from that contact application, can be configured to display the generated contact data to user A using a user interface 168.

In some embodiments, user data generated, processed and/or presented at the compute device 160 can be stored at an external storage device such as the storage device 152. The storage device 152 can be any type of device that can be operatively coupled to the compute device 160 and configured to store data received from the compute device 160. Such a storage device can be, for example, a large-scale storage facility such as a storage area network (SAN), a database server, etc. In some embodiments, the storage device 152 can be a portable storage device such as, for example, a removable hard drive, a portable memory card, a compact disk, etc. In some embodiments, a storage device operatively coupled to an OHA application can be referred to as an OHA Data Storage.

As shown in FIG. 1, the compute device 160 can be configured to send user data 190 to the storage device 152, such that the user data 190 can be stored at the storage device 152. The user data 190 can be the original user data generated, processed and/or presented at the compute device 160. Alternatively, the user data 190 can be a copy of the original user data generated, processed and/or presented at the compute device 160. In some embodiments, multiple copies of the original user data generated, processed and/or presented at the compute device 160 can be distributed to and then stored at more than one storage device (not show in FIG. 1) that is similar to the storage device 152. Additionally, although shown in FIG. 1 as the user data generated, processed and/or presented at the compute device 160 being stored at the external storage device 152, in some embodiments, the user data (or a copy of the user data) generated, processed and/or presented at the compute device 160 can be stored internally within the compute device 160 (e.g., in the memory of the compute device 160). Furthermore, the compute device 160 can be configured to retrieve user data from the storage device 152. For example, in response to receiving from the user device 112 a request to download user data, the compute device 160 can be configured to retrieve the corresponding user data from the storage device 152 and then send the retrieved user data to the user device 112.

In addition to storing user data in an external storage device (e.g., the storage device 152), user data generated, processed and/or presented at the compute device 160 can be backed up at the backup-restore device 120. Furthermore, the backup user data can be restored from the backup-restore device 120 to the compute device 160. As shown in FIG. 1, the compute device 160 is operatively coupled to the backup-restore device 120 via the network 170. The network 170 can be any type of network that operatively couples the compute device 160 and the backup-restore device 120. The network 170 can be implemented as a wired network, a wireless network, or a combination of wired and wireless network. In some embodiments, the network 170 can be, for example, a local area network (LAN), a wide area network (WAN), a virtual network, a telecommunications network, the Internet, etc. In some embodiments, for example, the backup-restore device 120 can be connected to the compute device 160 via an Internet service provider (ISP) and the Internet. In some embodiments, the backup-restore device 120 can be hosted at a location remote from the compute device 160 and operatively connected to and communicate with the compute device 160 via the network 170. In other embodiments, although not shown in FIG. 1, the backup-restore device 120 can be directly coupled to the compute device 160 without any intermediate device.

The backup-restore device 120 can be any device with the capabilities of collecting (or receiving), processing, storing, presenting and/or transmitting user data. Specifically, the backup-restore device 120 can be configured to receive or collect user data from the compute device 160 (e.g., receiving user data 192 from the compute device 160 at the backup-restore device 120 as shown in FIG. 1), process the received or collected user data, and/or store the processed user data at a storage device 154 (e.g., sending user data 194 from the backup-restore device 120 to the storage device 154 as shown in FIG. 1). In some embodiments, the backup-restore device 120 can be configured to function as, for example, a server device, a computing device, a data management device, and/or so forth.

As shown in FIG. 1, the backup-restore device 120 includes a processor 140, which includes a backup module 142 and a restore module 144; and a memory 130. Similar to the compute device 160, the backup-restore device 120 can be configured to host and execute one or more applications (e.g., applications 182, 186) that are configured to process and/or present user data received from the compute device 160. Although not shown in FIG. 1, in some embodiments, the backup-restore device 120 can include other components such as one or more network interface devices (e.g., a network interface card, a communication port) configured to connect the backup-restore device 120 to the network 170, the storage device 154, the user device 114, and/or other devices.

The processor 140 can be any processing device or component configured to perform the user data collecting, processing, presenting and/or transmitting functions as described herein. Each of the backup module 142 and the restore module 144 can be a hardware-based module (e.g., an Application-Specific Integrated Circuit (ASIC), a Digital Signal Processor (DSP), a Field Programmable Gate Array (FPGA)), a software-based module (e.g., a module of computer code executed at a processor, a set of processor-readable instructions executed at a processor and/or stored in memory), and/or a combination of hardware- and software-based modules. In some embodiments, the backup module 142 or the restore module 144 can be, for example, a process, application, virtual machine, and/or some other software module (stored in memory and/or executing in hardware) or a hardware module implemented at, for example, the processor 140 of the backup-restore device 120.

The backup module 142 can be configured to execute functions associated with receiving or collecting user data from the compute device 160, and storing the received or collected user data at the storage device 154. The restore module 144 can be configured to execute functions associated with presenting information of the user data stored at the storage device 154 to a user (e.g., user B as shown in FIG. 1), and restoring the user data upon a request from the user. Although shown in FIG. 1 as the backup module 142 and the restore module 144 being two separate modules, in some embodiments, the functions performed by the backup module 142 and the restored module 144 as described herein can be performed in a combined single module or distributed to more than two modules.

The memory 130 can be, for example, a random access memory (RAM) (e.g., a dynamic RAM, a static RAM), a flash memory, a removable memory, a memory buffer, a hard drive, and/or so forth. In some embodiments, the memory 130 can act as a data repository or buffer for the backup-restore device 120. In such embodiments, for example, the user data collected or received from the compute device 160 can be (temporarily) stored within the memory 130 before it is sent to the storage device 154. Additionally, in some embodiments, information (e.g., metadata) of the user data can be stored in the memory 130, such that the information of the user data can be presented to a user without retrieving the actual user data from the storage device 154.

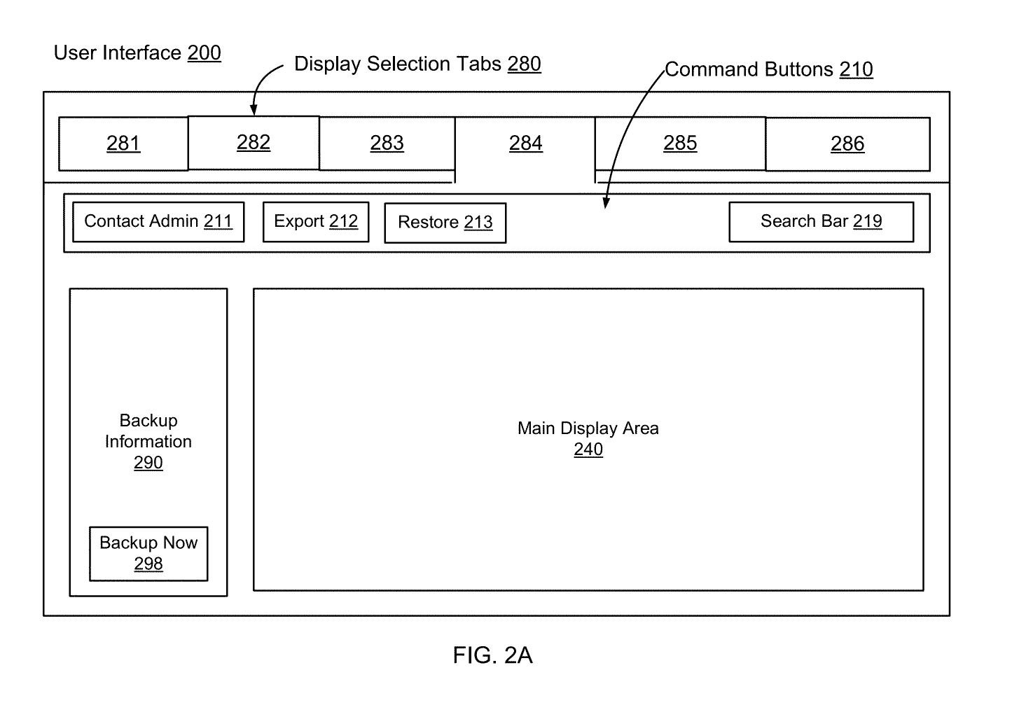

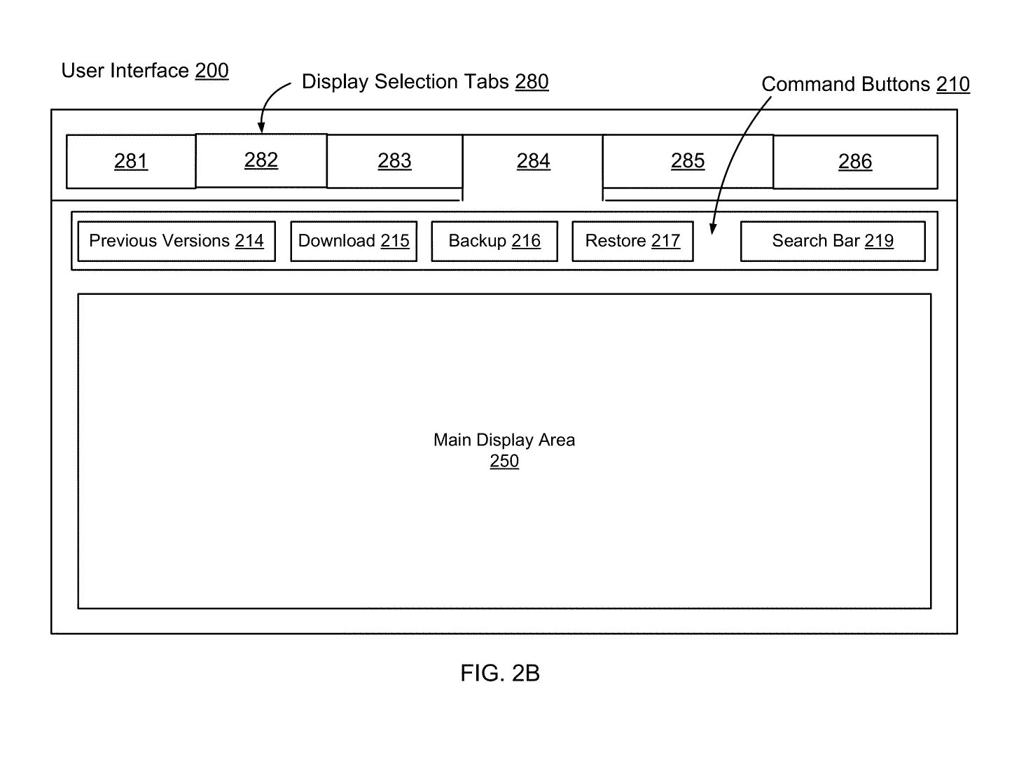

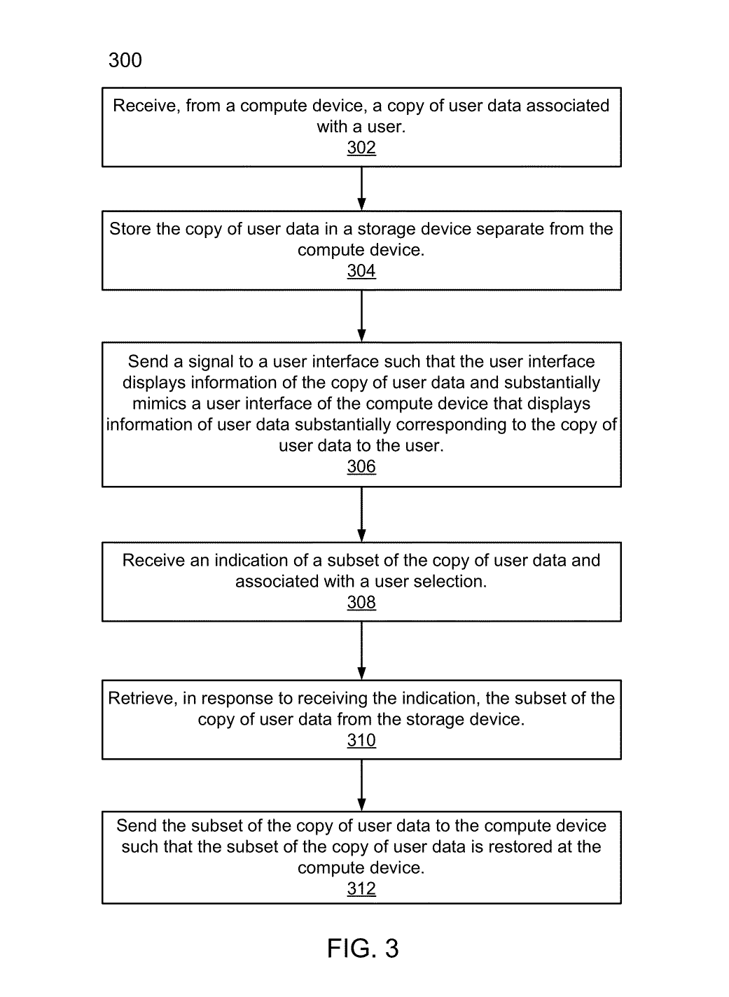

Similar to the applications 162 and 166 hosted and executed at the compute device 160, the applications 182 and 186 hosted and executed at the backup-restore device 120 can be configured to process and/or present user data (or information of user data) to users (e.g., user B) of the backup-restore device 120. Furthermore, similar to the user interfaces 164 and 168 provided by the applications of the compute device 160, the user interfaces 184 and 188 can be used to present user data or information of user data to the users of the backup-restore device 120. In performing the backup and/or restore functions, the applications 182, 186 can be executed by the backup module 142 and/or the restore module 144. In some embodiments, an application or a set of applications (e.g., the applications 182, 186) configured to perform the backup and restore functions can be referred to as a backup and restore application (BA). Details of the backup and restore functions are further described below and with respect to FIGS. 2A, 2B, and 3.

The storage device 154 can be functionally similar to the storage device 152 as described above. Specifically, the storage device 154 can be external to and operatively coupled to the backup-restore device 120. In some embodiments, such a storage device can be referred to as a BA Data Storage. In some embodiments, the storage device 154 can be located at a distinct, separate, and remote location from the compute device 160. In such embodiments, a copy of user data stored at the storage device 154 can be physically separate from the compute device 160 and the storage device 152, where the original user data is stored. As a result, the copy of user data is likely to be preserved in the case that the original user data is destroyed (e.g., due to a damage to the compute device 160 or the storage device 152). In some embodiments, similar to the compute device 160, the backup-restore device 120 can be configured to store the received user data internally within the backup-restore device 120 (e.g., in the memory 130). Additionally, in some embodiments, user data can be stored in an encrypted form at the storage devices 152, 154, or an internal memory of the backup-restore device 120 to secure the user data from unauthorized access.

User B and associated user device 114 can be similar to user A and the associated user device 112, respectively. In particular, user B can be the same user as user A or associated with user A. For example, user A and user B can be the same user that accesses and operates the compute device 160 (using the user device 112) to generate user data, and then accesses and operates the backup-restore device 120 (using the user device 114) to back up and/or restore the user data. For another example, user A and user B can be two authorized users belonging to the same organization or company; two operators with the same network administration authorization; two users (e.g., family members) sharing the same user account; and/or the like. In those cases, user A and user B can share the same credentials to access the corresponding applications of the compute device 160 and the backup-restore device 120. Similarly, the user device 114 can be the same as the user device 112 or functionally similar to the user device 112. In some embodiments (not shown in FIG. 1), similar to the user device 112, the user device 114 can be operatively coupled to the backup-restore device 120 via a network such as, for example, the Internet. Additionally, in some embodiments, similar to user A directly accessing and operating on the compute device 160, user B can access and operate on the backup-restore device 120 without using a user device or any other intermediate device.

A user (e.g., user B) can access the backup-restore device 120 (e.g., using the user device 114) to back up user data that is generated, processed and/or presented at the compute device 160. Specifically, the backup module 142 can be configured to execute an application (e.g., the application 182 or 186) of the backup-restore device 120 to receive or collect user data from a corresponding application (e.g., the application 162, 166) of the compute device 160. Initially, the application (e.g., the application 182 or 186) executed at the backup-restore device 120 can be authenticated to receive and process a copy of user data associated with (e.g., generated at) the corresponding application (e.g., the application 162 or 166) executed at the compute device 160 based on authorization information. The authorization information can be provided by user B that accesses and operates (e.g., using the user device 114) the associated application (e.g., the application 182 or 186) of the backup-restore device 120.

For example, user A can access the application 162 of the compute device 160 using a user account (e.g., via a user identification, a password and/or an OAuth token). User A then can operate the application 162 to generate user data. User B (e.g., the same user as user A or a different user associated with user A) can access the application 182 of the backup-restore device 120 using the same user account (e.g., via the same user identification, password and/or OAuth token). User B then can operate the application 182 to request a copy of the user data associated with the application 162.

The authentication for user B can be performed, for example, by the exchange between the application 162 and the application 182 of credentials (e.g., the user identification, password and/or OAuth token) associated with user A and user B. Specifically, the authorization information (e.g., the user identification, password and/or OAuth token) provided by user B can be sent from the backup-restore device 120 to the compute device 160 for verification. After user B is verified to be associated with the same user account as user A that generated the original user data at the compute device 160, user B is authenticated to receive and further process the copy of user data at the backup-restore device 120. Thus, the copy of user data can be sent from the compute device 160 to the backup device 120.

In some embodiments, after a user (e.g., user A or user B) is authenticated to operate an application (e.g., the application 182 or 186) of the backup-restore device 120 to receive user data from the compute device 160 and/or manipulate (e.g., view, restore, download) the user data at the backup-restore device 120, the authentication information provided by the user can be stored within the backup-restore device 120. Thus, when a new user (can be a user that was previously authenticated or a user that was not previously authenticated) requests to access and manipulate the same user data, the authentication information provided by the new user can be verified against the authentication information stored within the backup-restore device 120 without being sent to the compute device 160 for verification. The new user can be authenticated if her authentication information matches authentication information of a user that was previously authenticated. In other embodiments, the backup-restore device 120 does not store authentication information of users. As a result, authentication information of each new user is sent to the compute device 160 for verification.

In some embodiments, the backup-restore device 120 can be configured to collect data (e.g., copy of user data) from the compute device 160 using, for example, Hypertext Transfer Protocol (HTTP) Application Programming Interface (API) calls, scheduled data exports, automated data exports, data collection from user-interface screens, or any other suitable means. For example, the application 182 can be configured to generate and send a HTTP request message to the application 162 to request copy of user data. In response to receiving such a HTTP request message, and upon user B being authenticated, the application 162 can be configured to generate and send a HTTP response message including the requested copy of user data to the application 182.

In some embodiments, an application (e.g., the application 182 or 186) of the backup-restore device 120 can be configured to collect user data from an associated application (e.g., the application 162 or 166) of the compute device 160 on a one-time or ongoing basis, depending on the configuration of the corresponding applications. Furthermore, collection of user data from the compute device 160 can be performed automatically, periodically, in an event-driven fashion, in an on-demand fashion, or in any other suitable means based on the configuration of the corresponding applications. Such a configuration of rules for the collection of user data can be defined, for example, by a user manipulating a user interface provided by the application of the backup-restore device 120, as described below with respect to FIG. 2A. For example, the application 182 of the backup-restore device 120 can be configured to collect new email data from the application 162 of the compute device 160 whenever a new email is generated or received at the compute device 160, or an indication from a user is received at the backup-restore device 120. For another example, the application 186 of the backup-restore device 120 can be configured to collect the up-to-date contact data from the application 166 of the compute device 160 every Sunday evening.

After the user data is received or collected at the backup-restore device, the user data can be processed (e.g., modified, amended), and then sent to the storage device 154 to be stored. In some embodiments, “raw bytes” of the user data can be received from the compute device 160 and then stored at the storage device 154. That is, a copy of the original user data, which is identical to the original user data, is stored at the storage device 154. In other embodiments, a copy of the original user data after being processed at the backup-restore device 120 or at the compute device 160, which is not exactly identical to but substantially the same as the original user data, can be stored at the storage device 154. For example, additional metadata associated with the original user data (e.g., originator of the user data, time when the user data was generated, etc.) can be included in the copy of the user data that is stored at the storage device 154.

A user (e.g., user B) can access the backup-restore device 120 (e.g., using the user device 114) to restore user data stored at the storage device 154 to the compute device 160. Specifically, the restore module 144 can be configured to execute an application (e.g., the application 182 or 186) of the backup-restore device 120 to retrieve selected user data from the storage device 154 (e.g., retrieving user data 194 from the storage device 154 to the backup-restore device 120 as shown in FIG. 1), and then send the retrieved user data to the compute device 160 (e.g., sending user data 192 from the backup-restore device 120 to the compute device 160 as shown in FIG. 1) such that the user data is re-instantiated at a corresponding application (e.g., the application 162, 166) of the compute device 160. Initially, similar to the backup process described above, the application (application 182 or 186) executed at the backup-restore device 120 can be authenticated to restore the user data based on authorization information provided by the user. In some embodiments, as discussed above, user data is stored in the storage device 154 in an encrypted form. In such embodiments, only applications with the credentials and functionality to decrypt the user data can access and manipulate the user data stored in the storage device 154.

In some embodiments, an application (e.g., the application 182, 186) of the backup-restore device 120 can be configured to provide a user interface (e.g., a graphical user interface (GUI)) that allows a user to access, manipulate, restore or perform other functions on the user data associated with the application. In some embodiments, such a user interface provided by the application of the backup-restore device 120 can substantially mimic a user interface provided by a corresponding application at the compute device 160. That is, the user can view, manipulate or perform other related functions on the copy of user data using the user interface of the backup-restore device 120 in the same or a substantially similar way as the user viewing, manipulating or performing the other related functions on the original user data using the user interface of the compute device 160. Furthermore, in some embodiments, the copy of user data or information of the copy of user data can be displayed to the user accessing the backup-restore device 120 in the same or a substantially similar way as the original user data or information of the original user data being displayed to the user accessing the compute device 160. For example, the user interface 184 provided by the application 182 can substantially mimic the user interface 164 provided by the application 162 to view and operate on email data. For another example, the user interface 188 provided by the application 186 can substantially mimic the user interface 168 provided by the application 166 to view and operate on contact data. Details of the user interface are shown and described below with respect to FIGS. 2A and 2B.

In some embodiments, a user interface to view, navigate and/or operate on a copy of user data at the backup-restore device 120 can be different for each type of application that generated the original user data at the compute device 160. That is, each type of application executed at the compute device 160 and the related presentation of the associated user data at the compute device 160 can be related to a manner in which an associated user interface presents the copy of the user data at the backup-restore device 120. For example, a copy of email data stored at the storage device 154 and initially presented by an email application (e.g., the application 162) at the compute device 160 can be presented by a user interface (e.g., the user interface 184) of the backup-restore device 120 that is associated with presenting email data. The user interface can substantially mimic a user interface (e.g., the user interface 164) that presents email data at the compute device 160. As a result, the copy of email data can be displayed in a manner substantially similar to the manner in which the original email data was initially displayed by the email application at the compute device 160. For another example, a copy of contact data stored at the storage device 154 and initially presented by a contacts application (e.g., the application 166) at the compute device 160 can be presented by a user interface (e.g., the user interface 188) of the backup-restore device 120 that is associated with presenting contact data. The user interface can substantially mimic a user interface (e.g., the user interface 168) that presents contact data at the compute device 160. As a result, the copy of contact data can be displayed in a manner substantially similar to the manner in which the original contact data was initially displayed by the contact application at the compute device 160.

In some embodiments, as described above, different user interfaces can be provided to display different types of user data. For example, the user interfaces 184 and 188 can be used to display email data and contact data, respectively. In other embodiments, a common user interface can be provided by an application of the backup-restore device 120 to display various types of user data. In such embodiments, such a common user interface can determine the type of user data being displayed so that it automatically displays user data in the correct form based on the corresponding application at the compute device 160 from which the underlying user data was originally copied. For example, a common user interface can determine the format of the user data or identify the corresponding application at the compute device 160 at which the user data was generated. Based on this determined format or identified application, the user data can be displayed within the common user interface in an appropriate (e.g., mimicking) format. In some embodiments, the application of the backup-restore device 120 can be configured to determine the format of the user data, for example, through metadata stored during the storage of the user data at the storage device 154. Such metadata can indicate the type or format of the user data. In addition or alternatively, such metadata can be used to identify the application of the compute device 160 from which the user data was initially generated.

FIG. 2A is a schematic illustration of a user interface 200 configured to display information for backup user data, according to an embodiment. Similar to the user interfaces 184, 188 shown and described with respect to FIG. 1, the user interface 200 can be associated with (e.g., provided by) an application of a backup-restore device that is similar to the application 182 or 186 of the backup-restore device 120 in FIG. 1. The user interface 200 can be displayed on a display device or component (e.g., a screen, a monitor) of the backup-restore device or a user device (e.g., the user device 114 in FIG. 1), such that a user (e.g., user B in FIG. 1) operating the backup-restore device or the user interface can view and/or navigate a copy of user data in ways that substantially mimic the organization of the original user data as displayed by a corresponding user interface of a compute device (e.g., the user interfaces 164, 168 of the compute device 160 in FIG. 1).

As shown in FIG. 2, the user interface 200 includes a set of sub-display areas such as an area to display a set of display selection tables 280, an area to display a set of command buttons 210, a main display area 240, an area to display backup information 290, and/or the like. In some embodiments, the user interface 200 can include more or less sub-display areas, which can be arranged in any other suitable manner to display information associated with the backup user data to a user.

The set of display selection tabs 280 (including tabs 281-286) can be displayed at the top (as shown in FIG. 2A) or any other position of the user interface 200. Each display selection tab 280 corresponds to a different category of contents, data or information associated with the backup user data or the user. Such display selection tabs 280 can include, for example, backups, services, account, notifications, admin, etc. When a particular display selection tab 280 is selected by the user, the corresponding contents, data and/or information is displayed on the main display area 240 and the area to display the backup information 290. For example, when the display selection tab 284, backup, is selected as shown in FIG. 2A, information of the backup user data is displayed in the main display area 240 and the area for the backup information 290. For another example, when the display selection tab for account is selected, information of the user account for the current user (e.g., user B in FIG. 1) can be displayed at the main display area 240 and/or other sub-display areas. For yet another example, when the display selection tab for services is selected, configuration information associated with backup rules and/or schedules can be displayed at the main display area 240. The user can then modify the existing rules and/or schedules or define new rules and/or schedules for the backup operations.

The command buttons 210 can be displayed under the display selection tabs 280 (as shown in FIG. 2A) or any other position of the user interface 200. Each command button 210 corresponds to a specific command associated with the backup user data. As shown in FIG. 2A, such command buttons can include, for example, a contact admin button 211, an export button 212, a restore button 213, etc. When a command button 210 is activated (e.g., clicked or selected), the associated command can be executed. For example, when the contact admin button 211 is activated (or clicked, selected), a window can be popped up to allow the user to write an email to the administrator of the backup-restore device. For another example, when the export button 212 is activated (or clicked, selected), information of the backup user data displayed in the main display area 240 and/or the backup information 290 can be exported to a location specified by the user. For yet another example, when the restore button 213 is activated (or clicked, selected), a subset of user data selected by the user can be restored. That is, the selected subset of user data can be retrieved from a storage device (e.g., the storage device 154 in FIG. 1) where the user data is stored, and then sent to the compute device (e.g., the compute device 160 in FIG. 1) such that the selected subset of user data can be restored at the compute device. Furthermore, in some embodiments, the restore button 213 can be used to restore multiple or all the pieces of user data (e.g., multiple emails, multiple contacts) that are selected in the main display area 240. In some embodiments, the restore button 213 can be used to perform a full-restore function on the user data.

In some embodiments, a search bar 219 can be included along with the command buttons 210 or at any other position of the user interface 200. The search bar 219 can provide the user a method to search the user data for specific terms that identify the user data being sought for restore. For example, the user can type a keyword in the search bar 219 and then press the enter key or click (activate, select) a button next to the search bar 219 (not shown in FIG. 2A). As a result, the keyword is searched within the user data stored at the storage device, and the result can be returned and displayed at, for example, the main display area 240.

In some embodiments, the display selection tabs 280 and the command buttons 210 can be implemented using any suitable method such as a graphical user interface (GUI) element (e.g., a knob, a drop-down menu, a list of selectable items, a navigation tree, a content pane, etc.). In such embodiments, the GUI element can be displayed in the user interface 200, and the user can select a display selection or activate a command by manipulating the GUI element accordingly (e.g., selecting an item in the drop-down menu, etc.).

When the selection tab 280 for backups is selected by the user, the main display area 240 and the area for the backup information 290 can be configured to display backup user data and/or information of the backup user data. The backup user data and/or information of the backup user data can be displayed in any suitable manner depending on the type of user data and configuration defined by the user. For example, when the backup user data is email data, the main display area 240 can be configured to display a list of email information, where each item in the list includes a subject, sending party and date of an email. For another example, when the backup user data is contact data, the main display area 240 can be configured to display a table of contact information, where each item in the table includes a name and affiliated organization of a contact.

In some embodiments, additional information or metadata of the backup user data can be displayed in the area for the backup information 290. Such additional information can include, for example, when was the last backup, how many backups have been performed, when is next scheduled backup, and so forth. Furthermore, a “backup now” button 298 can be displayed in the user interface 200. When the user selects a subset of user data (e.g., one or more emails from the list for email information, one or more contacts from the table of contact information) within the main display area 240 and then activates (e.g., clicks, selects) the “backup now” button 298, the selected user data can be backed up from the compute device subsequently. That is, a copy of the up-to-date user data corresponding to the selected user data is sent from the compute device to the backup-restore device, and then stored at the storage device.

Similarly, when the user selects a subset of user data within the main display area 240 and then activates (e.g., clicks, selects) the restore button 213, the selected user data can be restored to the compute device. In some embodiments, once a subset of user data is selected within the main display area 240, the user can restore the selected user data through a single step such as a click on the restore button 213 without any additional operation. As a result, the selected subset of user data can be transmitted from the storage device associated with the backup-restore device to a storage device associated with the compute device, via the backup-restore device, a network (e.g., the Internet), and the compute device. Once transmitted to the storage device associated with the compute device, the subset of user data can be re-instantiated at the compute device and then be available and usable within the originating application at the compute device. In such embodiments, the user interface 200 provides a user-friendly process to allow the user to restore user data.

FIG. 2B is a schematic illustration of the user interface 200 configured to display information for backup user data, according to another embodiment. Particularly, the user interface 200 shown in FIG. 2B can be used to display detailed information of selected subset of user data to the user (e.g., user B in FIG. 1), after the user selects the specific subset of user data at the user interface 200 shown in FIG. 2A and sends a signal to access the detailed information. In some embodiments, unlike the restore button 213 in FIG. 2A that can be used to restore multiple or all the pieces of user data (e.g., multiple emails, multiple contacts), the restore button 217 can be used to restore only the selected specific piece of user data (e.g., a single email, a single contact) that is displayed in the main display area 250.

For example, after the user selects a specific item corresponding to an email from the list of email information and sends an indication to view details (e.g., double clicks the specific item, clicks on a link associated with that specific item, etc.), the contents displayed on the user interface 200 changes from that shown in FIG. 2A to that shown in FIG. 2B. As a result, detailed information of the selected email is displayed in the main display area 250. Such detailed information can include, for example, a receiving party, length, subject matter, label, etc., of the selected email. Furthermore, in some embodiments, the detailed information of the selected email can be displayed based on email fields common to the originating email application at the compute device, where the email data was initially generated.

For another example, after the user selects a specific item corresponding to a contact from the table of contact information and sends an indication to view details (e.g., double clicks the specific item, clicks on a link associated with that specific item, etc.), the contents displayed on the user interface 200 changes from that shown in FIG. 2A to that shown in FIG. 2B. As a result, detailed information of the selected contact is displayed in the main display area 250. Such detailed information can include, for example, a phone number, email address, home address, etc., of the selected contact. Furthermore, in some embodiments, the detailed information of the selected contact can be displayed based on fields common to the originating contact application at the compute device, where the contact data was initially generated.

The display selection tabs 280 (including the tabs 281-286) shown in FIG. 2B are the same as the display selection tabs 280 shown and described with respect to FIG. 2A. The search bar 219 shown in FIG. 2B is substantially the same as the search bar 219 shown and described with respect to FIG. 2A. The command buttons 210 shown in FIG. 2B can be different from the command buttons 210 shown and described with respect to FIG. 2A. For example, when the download button 215 is clicked (activated, selected), the detailed information of the selected user data or the selected user data itself, which is displayed in the main display area 250, can be downloaded from the backup-restore device to a user device associated with the user. For another example, when the backup button 216 is clicked, similar to the scenario of the “backup now” button 298 shown and described with respect to FIG. 2A, the selected user data associated with the displayed information in the main display area 250 can be backed up subsequently. That is, a copy of the up-to-date user data corresponding to the selected user data is sent from the compute device to the backup-restore device, and then stored at the storage device.

The restore button 217 is functionally similar to the restore button 213 shown and described with respect to FIG. 2A. Specifically, when detailed information of selected user data is displayed in the main display area 250 and the user activates (e.g., clicks, selects) the restore button 217, the selected user data can be restored to the compute device. Particularly, the selected user data can be restored through the single operation of clicking (activating, selecting) the restore button 217 without any additional operation.

In some embodiments, as described above with respect to FIG. 1, the user interface 200 of the backup-restore device can substantially mimic a user interface provided by an application of the compute device to present information of the user data in any suitable format. For example, as described with respect to FIG. 2A, the user interface 200 can substantially mimic a user interface provided by an originating application of the compute device through the display of user data in a list, where groups of user data items in similar types are displayed, typically with column headings indicating the originating application's contextual fields. In addition, as described with respect to FIG. 2B, the user interface 200 can substantially mimic a user interface provided by the originating application of the compute device through the detailed display of an individual item of user data, where the item itself is displayed as close as possible to the original display of the item at the application at the OHA.

FIG. 3 is a flowchart illustrating a method 300 for backing up and restoring user data, according to an embodiment. Instructions associated with the method 300 can be stored in a memory of a backup-restore device (e.g., the memory 130 of the backup-restore device 120 in FIG. 1) and executed at a processor of the backup-restore device (e.g., the processor 140 of the backup-restore device 120 in FIG. 1). Furthermore, similar to the backup-restore device 120 shown and described with respect to FIG. 1, the backup-restore device that performs the method 300 can be operatively coupled to a user device operated by a user (e.g., the user device 114 operated by user B in FIG. 1), a storage device (e.g., the storage device 154 in FIG. 1), and a compute device (e.g., the compute device 160 in FIG. 1).

At 302, a copy of user data associated with the user can be received from the compute device at the backup-restore device. In some instances, user data substantially corresponding to the copy of user data associated with the user can be generated, collected, processed and/or presented at the compute device. For example, the user data substantially corresponding to the copy of user data can be presented by a user interface at the compute device to the user. In some instances, the copy of user data can be received from the compute device via a network (e.g., the network 170 in FIG. 1) such as, for example, the Internet. In some instances, the copy of user data can be received using, for example, HTTP API calls, scheduled data exports, automated data exports, and/or the like.

At 304, the copy of user data can be stored in a storage device. The storage device can be separate and remote from the compute device (e.g., storage device 154 associated with backup-restore device 120 in FIG. 1). As a result, in case of failure of the compute device, the storage device and the copy of user data stored in the storage device are unlikely to be affected. Thus, the copy of user data can be safely preserved at the storage device.

At 306, a signal can be sent to a user interface of the backup-restore device such that the user interface displays information of the copy of user data and substantially mimics the user interface of the compute device that displays information of the user data substantially corresponding to the copy of user data to the user. The user interface of the backup-restore device can be structurally and functionally similar to the user interface 200 shown and described with respect to FIGS. 2A and 2B. Particularly, the user interface of the backup-restore device can be configured to display copy of the user data (or information of the copy of the user data) in a substantially similar way as the user data substantially corresponding to the copy of user data (or information of the user data) being displayed to the user using the user interface of the compute device. Thus, the user can view and manipulate the copy of user data via the user interface of the backup-restore device in a substantially similar way as the user viewing and manipulating the user data via the user interface of the compute device.

At 308, an indication of a subset of the copy of user data can be received at the backup-restore device. Such an indication can be associated with a user selection. For example, when a list of email data is displayed in the user interface of the backup-restore device, one or more items of email data can be selected from the list of email data by checking the corresponding items (e.g., clicking on a box associated with each item). For another example, as described with respect to FIGS. 2A and 2B, an item of contact data can be selected from a table of contact data by double clicking on a link associated with the item of contact data that is displayed on the user interface.

At 310, in response to receiving the indication, the subset of the copy of user data can be retrieved from the storage device. After the subset of the copy of user data is selected by the user, the user can indicate to restore the selected subset of the copy of user data to the compute device. As a result, the selected subset of the copy of user data is retrieved from the storage device to the backup-restore device. In some embodiments, as described with respect to FIGS. 2A and 2B, the user can send the indication by performing, for example, a one-step operation. Such a one-step operation can be, for example, clicking on a restore button (e.g., the restore button 213 in FIG. 2A and the restore button 217 in FIG. 2B), pressing a designated shortcut key on a keyboard (e.g., of a user device operatively coupled to the backup-restore device), or performing any other suitable method. In other embodiments, the user can send the indication of restoring the selected subset of the copy of user data by performing multiple-step operations. For example, the user can go through a series of steps to determine a suitable method of transmitting the data, a scope of data to be restored, an appropriate location to send the data to, and/or the like.

At 312, the retrieved subset of the copy of user data can be sent to the compute device such that the subset of the copy of user data is restored at the compute device. Specifically, in response to receiving the subset of the copy of user data, the compute device can be configured to store the subset of the copy of user data at, for example, a storage device coupled to the compute device (e.g., the storage device 152 in FIG. 1). The compute device can then be configured to access, view and manipulate the corresponding user data by retrieving the subset of the copy of user data from the storage device.

While various embodiments have been described above, it should be understood that they have been presented by way of example only, not limitation, and various changes in form and details may be made. Where methods described above indicate certain events occurring in certain order, the ordering of certain events may be modified. Additionally, certain of the events may be performed concurrently in a parallel process when possible, as well as performed sequentially as described above. Any portion of the apparatus and/or methods described herein may be combined in any combination, except mutually exclusive combinations. The embodiments described herein can include various combinations and/or sub-combinations of the functions, components and/or features of the different embodiments described.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, or other programming languages (e.g., object-oriented programming languages) and development tools. Additional examples of computer code include, but are not limited to, control signals, encrypted code, and compressed code.

What is claimed is:

1. An apparatus, comprising:
a backup module configured to receive, from a compute device, a copy of user data associated with a user and generated at the compute device, the backup module being separate from the compute device,
the backup module configured to store the copy of user data in a storage device operatively coupled to the backup module and separate from the compute device, the backup module configured to provide a user interface for the user to access the copy of user data stored in the storage device,
the backup module configured to receive, from a user device associated with the user, an indication of a subset of the copy of user data,
the backup module configured to, in response to the indication, retrieve the subset of the copy of user data from the storage device and send the subset of the copy of user data to the compute device such that the subset of the copy of user data is restored at the compute device.

2. The apparatus of claim 1, wherein the copy of user data substantially corresponds to user data generated within a Software as a Service (SaaS) application at the compute device, the backup module is configured to send the subset of the copy of the user data to the compute device such that the SaaS application accesses the subset of the copy of the user data.

3. The apparatus of claim 1, wherein the storage device is a first storage device, user data substantially corresponding to the copy of user data is stored in a second storage device operatively coupled to the compute device and different from the first storage device.

4. The apparatus of claim 1, wherein the backup module is configured to be operatively coupled to the compute device via the Internet.

5. The apparatus of claim 1, wherein the backup module is configured to receive the copy of user data from the compute device using at least one of Hypertext Transfer Protocol (HTTP) Application Programming Interface (API) calls, scheduled data exports, or automated data exports.

6. The apparatus of claim 1, wherein the backup module is authenticated by the user to receive and store the copy of user data associated with the user.

7. The apparatus of claim 1, wherein the user interface substantially mimics a user interface that displays information of user data substantially corresponding to the copy of user data.

8. The apparatus of claim 1, wherein the user data is generated by a first application at the compute device, the user interface is a first user interface provided by the backup module,
the backup module is configured to receive, from the compute device, a copy of user data generated by a second application at the compute device, the backup module configured to store the copy of user data generated by the second application in the storage device and provide to the user device a second user interface to access the copy of user data generated by the second application and stored in the storage device, the second user interface being different from the first user interface.

9. The apparatus of claim 1, wherein the backup module is separate from the user device.

10. The apparatus of claim 1, wherein the backup module is configured to receive the copy of user data from the compute device without the copy of user data being received at the user device, the backup module configured to send the subset of the copy of user data to the compute device without sending the subset of the copy of user data to the user device.

11. A method, comprising
receiving, from a compute device, a copy of user data associated with a user;
sending a signal to a user interface such that the user interface displays information of the copy of user data and substantially mimics a user interface of the compute device that displays information of user data substantially corresponding to the copy of user data to the user;
receiving an indication of a subset of the copy of user data and associated with a user selection;
sending, in response to receiving the indication, the subset of the copy of user data to the compute device such that the subset of the copy of user data is restored at the compute device.

12. The method of claim 11, wherein the user data substantially corresponding to the copy of user data is generated at the compute device.

13. The method of claim 11, further comprising:
storing the copy of user data in a storage device separate from the compute device; and
retrieving, in response to receiving the indication, the subset of the copy of user data from the storage device.

14. The method of claim 11, wherein:
receiving the copy of user data from the compute device includes receiving the copy of user data from the compute device via the Internet,
sending the subset of the copy of user data to the compute device includes sending the subset of the copy of user data to the compute device via the Internet.

15. The method of claim 11, wherein receiving the copy of user data from the compute device includes receiving the copy of user data from the compute device using at least one of Hypertext Transfer Protocol (HTTP) Application Programming Interface (API) calls, scheduled data exports, or automated data exports.

16. The method of claim 11, wherein the user data substantially corresponding to the copy of user data is generated by a first application at the compute device, the user interface is a first user interface, the method further comprising:
receiving, from the compute device, a copy of user data generated by a second application at the compute device,
sending a signal to a second user interface different from the first user interface such that the second user interface displays information of the copy of user data generated by the second application.

17. An apparatus, comprising:
a restore module configured to be operatively coupled to a storage device and a compute device, the restore module configured to store a copy of user data associated with a user in the storage device, the restore module configured to provide to a user device associated with the user a user interface to access the copy of user data,
the restore module configured to receive, from the user device, an indication of a one-step operation on the user interface and associated with a subset of the copy of user data,
the restore module configured to, in response to the indication, retrieve the subset of the copy of user data from the storage device and send the subset of the copy of user data to the compute device such that the subset of the copy of user data is restored at the compute device.

18. The apparatus of claim 17, wherein the one-step operation is a click on the user interface.

19. The apparatus of claim 17, wherein the restore module is configured to retrieve and send the subset of the copy of user data in response to the indication without receiving any other input from the user device.

20. The apparatus of claim 17, wherein the storage device is a first storage device, user data substantially corresponding to the copy of user data is generated at the compute device and stored in a second storage device different from the first storage device.

21. The apparatus of claim 17, wherein the restore module is authenticated by the user to store the copy of user data in the storage device and send the subset of the copy of user data to the compute device.

22. The apparatus of claim 17, wherein the user interface substantially mimics a user interface provided by the compute device to access user data substantially corresponding to the copy of user data.

23. The apparatus of claim 17, wherein the user interface includes a search function such that the user can search contents from the copy of user data stored in the storage device.
